(19) United States
(12) Patent Application Publication
(10) Pub. No.: US 2013/0319893 A1
(43) Pub. Date: Dec. 5, 2013

(54) BEVERAGE CONTAINER WITH RANDOMLY GENERATED IDENTIFIER AND METHOD

(71) Applicant: Ray Alan TOMS, Golden, CO (US)

(72) Inventor: Ray Alan TOMS, Golden, CO (US)

(73) Assignee: MILLERCOORS, LLC, Golden, CO (US)

(21) Appl. No.: 13/488,990

(22) Filed: Jun. 5, 2012

(51) Int. Cl. B65D 85/00; B65C 3/00

(52) U.S. Cl. 206/459.1; 29/592; 156/64

(57) ABSTRACT

A beverage container is provided, including an integral indicator of a prize for a consumer. The indicator includes two components, namely, a marker and at least one symbol. The marker or symbol is randomly located around the circumference of the container. Alternatively, both the symbol and marker may be randomly located. The resulting orientation of the marker and a pre-selected winning symbol dictates whether the consumer has won a prize. One or more sets of markers and corresponding symbols may be provided on the container to indicate multiple prizes, or a progression of events corresponding to one or more prizes.

### FIELD OF THE INVENTION

The invention relates to containers with identifiers placed thereon in a random manner, and more particularly, to beverage containers incorporating randomly generated identifiers for purposes of identifying an aspect of the container or to communicate a message to a consumer such as whether the consumer has won a prize.

### BACKGROUND OF THE INVENTION

It is well known in advertising of commercial products to offer consumers prizes associated with the purchase of a product. For example, the cap or top of a container may include a symbol advising the consumer as to whether the consumer has won a prize. Other examples of marketing methods to advise the consumer as to the status of the product and/or whether the consumer has won a prize includes “scratch” tickets in which the consumer removes an upper layer of the ticket to expose a symbol indicating whether the consumer has won a prize. Another example includes a string of symbols or characters printed on the product or packaging that matches a winning symbol also printed on the product or packaging.

Although the designation of a prize winner may be achieved by random criteria, or by a combination of random factors, there is typically some amount of control asserted by the sponsor of the contest or prize offering in which the sponsor intervenes to ensure there are both a minimum and maximum number of winners associated with the contest or prize offering. For example, even with randomly generated numbers to match a winning number, there are calculated odds than can predictably determine whether launching the contest will result in too many winners or too few winners. Therefore, there is certainly some degree of control associated with the contest/prize offering in which some limits must be established for winning and losing.

For consumer contests/prize offerings, there is a need to administer these in a more simple manner yet maintain at least some predictability in terms of the number of winners and losers while maintaining some degree of random chance. There is also a need to provide a system and method for administering contests/prize offerings in which minimal efforts are required to modify the product or packaging. Further, there is a need to administer contests/prize offerings within the products so that the results of the contest/prize offer are readily viewable by the consumer. Contests/prize offerings that require additional consumer actions may not be the optimal manner in which to promote the product since there is a lack of instant gratification or at least a lack of instant knowledge as to the outcome. One example of delayed prize notifications includes those contests/prize offerings that require the consumer to use a computer to complete an online verification process or to generate correspondence to obtain the prize.

### SUMMARY

The invention includes a beverage container with a randomly generated identifier for purposes of conveying information to a consumer, such as whether a consumer has won a prize. The term “prize” as used herein means a broad range of benefits provided to the consumer, such as a monetary award, a discount for future purchases, qualification for a subsequent contest or drawing, an award of merchandise or any other item of value. A “prize offering” includes the game or contest provided to the consumer in order to win the prize. The identifier includes two elements, namely, a marker and one or more symbols.

In one preferred embodiment, the container includes a marker that is formed on or applied to the container. The marker is randomly located when formed on or applied to the container. In addition to the marker, one or more symbols are placed on the container in a position or orientation with respect to the marker such that a visible relationship is evident from the location of the marker with respect to the one or more symbols. The marker may be in the shape of an arrow or some other type of image indicating alignment with respect to one or more adjacent symbols. The symbols may include numbers, letters, images of objects, colors, designs, and combinations thereof. The symbols are preferably spaced along at least a portion of the circumference of the container, and the marker is located at a position such that the marker is aligned with at least one of the symbols. A symbol represents a potential prize based upon pre-established criteria in which a pre-selected symbol is a prize winner if the marker aligns with the pre-selected symbol. The sponsor or owner of the prize offering can establish which symbols represent prizes, and which combination of symbols may represent prizes if more than one set of symbols and markers are used.

One feature of the invention is the random manner in which the marker is located on the container. The symbols may also be located on the container in a random manner. The marker may be applied or formed on the container in a number of ways to include by printing or etching on the container, or the marker may be a piece of adhesive label material applied to the container. The symbols may also be applied or formed on the container in a number of ways to include by etching or printing on the container, or the symbols may be incorporated on a label applied to the body of the container. For bottles, the marker and symbols may also be applied to the neck of the bottle.

During a bottle labeling process for bottles having a circular cross section, a label is typically randomly located on the exterior surface of the bottle without requiring the label to be placed on any particular portion of the surface circumference. Thus if the symbols are part of the label, the symbols will be randomly located as well along the surface circumference. The marker may also be located in a random manner to some portion of the exterior surface of the container, but must be located in a position to “point” to one or more of the symbols. Therefore, the indication of whether a prize has been won can be a function of two randomly placed elements, namely, the marker and the symbols. This random indication of a prize provides a unique marketing tool that may increase the consumer's interest in the product.

For a metallic container such as a beverage can, the marker may be applied to the top end of the container prior to attaching the can end to the body of the container. The alignment between the marker and the symbol(s) on the sidewall of the can provides the indication whether the consumer has won a prize. Can ends are attached to can bodies in a random manner, that is, since both can ends and container bodies have circular cross sections, there are no pre-configured points of alignment or shape limiting features that require a can end to be attached with any particular circumferential orientation to a can body. Thus, attaching the can end to the body of the can results in a random event in terms of the circumferential orientation between the can end and can body.

In viewing the invention in yet another aspect, there can be three random or chance events associated with use of a marker and symbol on a metallic container, namely (1) the placement of the marker on the can end in which the marker is randomly placed at some point along the circumference of the can end; (2) the placement of the symbol(s) on the can body in which the symbol(s) are placed at some random location along the circumference of the exterior surface of the can body; and (3) the alignment between the marker and the symbol(s) on the can body when the can end is attached to the can body.

In another embodiment of the invention, the marker may be applied to the cap or crown used with a plastic or glass container, and the symbol is applied to the neck of the container such as by etching, printing, or a neck label in which the symbol is incorporated.

In yet another embodiment, for a metallic container, the marker may be applied directly to the body of the container in a first step, and then the symbols are applied to the container in a subsequent second step. In this embodiment, both the marker and the symbols may be applied by etching, printing, or by labels in which the marker and symbols are incorporated.

In yet another embodiment, it is contemplated that more than one marker and more than one set of symbols can be used to determine whether the consumer has won a prize. Accordingly, the determination of a prize can be determined by an evaluation of at least two relationships between markers and their corresponding symbols.

The random locations of both the marker and the symbols provide a unique and interesting way in which prizes can be determined. Because of the truly random nature in how the symbols and markers are located on the containers, this feature of the invention adds to the marketing potential of the invention.

Further, it is contemplated that the markers, the symbols or both the markers and symbols can be hidden from view from the consumer so the consumer would not have the capability to simply sort through numerous containers to find a winner. The symbols and/or markers can be hidden by removable adhesive pieces of label material, or can be hidden by an overcoat layer, such as a wax overcoat layer used for common scratch tickets.

Because of at least one chance event associated with the randomly generated identifier, a random number of containers will have a prize winning outcome for the consumer. The sponsor or owner of the prize offering can determine how many and what types of symbols represent a prize if a marker aligns with the designated or pre-selected symbols(s).

Therefore, in accordance with one aspect of the invention, an embodiment of the invention can be viewed as a container with a randomly generated identifier defined by: (i) a container; (ii) at least one symbol placed on the container; (iii) a marker placed on the container adjacent the symbol to indicate alignment between the marker and symbol; (iv) at least one of the marker or symbol being circumferentially randomly located on the container; and (v) the at least one symbol representing a potential prize based upon pre-established criteria in which a pre-selected symbol is a prize winner if the marker aligns with the pre-selected symbol.

In accordance with another aspect of the invention, an embodiment of the invention can be viewed as a method of generating a random identifier incorporated on a container, the method comprising: (i) providing a container; (ii) locating at least one symbol on the container; (iii) locating a marker on the container and positioned adjacent the symbol to indicate alignment between the marker and the symbol; (iv) the marker or symbol being randomly circumferentially applied on the container; and wherein the at least one symbol represents a potential prize based upon pre-established criteria in which a pre-selected symbol is a prize winner if the marker aligns with the pre-selected symbol.

Other features and advantages of the invention will become apparent from a review of the following detailed description take in conjunction with the drawings.

### BRIEF DESCRIPTION OF THE DRAWINGS

FIGS. 1 and 2 illustrate a prior art method of securing a top end of a container to a body of the container;

FIG. 3 illustrates an example prior art labeling machine in which a labels is applied to a designated location along the height of the container, but is applied randomly along the circumference of the container;

FIG. 4 illustrates an example prior art capping machine in which a cap or crown is secured to the mouth of the container;

FIG. 5 illustrates a perspective view of a beverage container with the randomly generated identifier in a first embodiment;

FIG. 6 illustrates a perspective view of another container with the randomly generated identifier in a second embodiment;

FIG. 7 is a top plan view of the top end of the beverage container of FIG. 6;

FIG. 8 illustrates a perspective view of another beverage container with the randomly generated identifier in another embodiment; and

FIG. 9 illustrates a perspective view of yet another beverage container with the randomly generated identifier in another embodiment.

### DETAILED DESCRIPTION

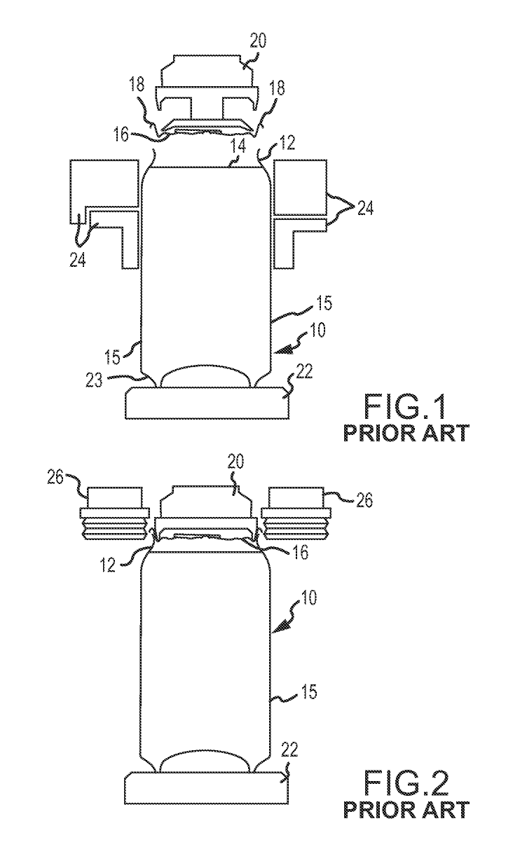

FIGS. 1 and 2 illustrate a prior art can assembling machine. The can 10 depicted in the FIGS. 1 and 2 are intended to represent a standard metallic container used to hold an amount of a beverage 14. After the container 10 has been filled with the beverage 14, the can end 16 is attached to the upper end 12 of the container body 15. FIGS. 1 and 2 are intended to illustrate a standard can assembly machine in which the body of the can 15 is held in place by a conveying platform 22 and the base 23 of the container rests on the conveyer. One or more can-holding chucks 24 hold the container body 15 in an upright, stabilized position. A can end holding element 20 holds the can end 16, and lowers the same over the container body. As shown in FIG. 2, once the can end has been placed over the upper end 12 of the container, one or more double-seaming chucks 26 join the can end 16 to the can body 15 by seaming the peripheral flange 18 of the can end to the upper end 12 of the container body 15. A double-seaming chuck 26 is well known for creating a double seam connection between the can end and can body. Both the circumferential orientation of the can body and the can end are random. That is, because the can body and the can end both have substantially circular circumferences, the can end and can body may be held in an infinite number of circumferential orientations prior to being joined. Accordingly, when the can end is secured to the body of the can, there is no predetermined or pre-established circumferential orientation of the can body with the can end.

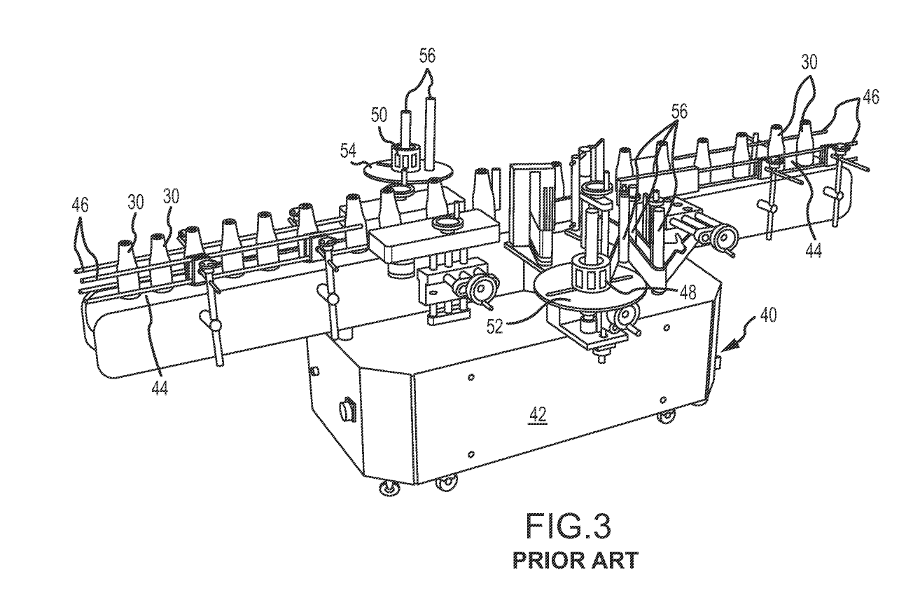

Referring to FIG. 3, another prior art device is shown, namely, a label applying machine 40. FIG. 3 is intended to represent a standard label applying machine in which one or more labels are applied to a container randomly in terms of the circumferential location of the label on the body of the container. Some of the basic elements of a label applying machine may include a base control unit 42 that may include a motor (not shown) for driving a conveyor 44, a programmable logic controller (not shown) for controlling the operation of the labeling machine, and other mechanical/electrical components. Side rails 46 are used in conjunction with the conveyor 44 in order to maintain the containers 30 in an upright, stabilized orientation. The label applying machine may include one or more labeling stations. As illustrated in the example of FIG. 3, the machine 40 has a primary labeling station including a spool 52 that holds a roll of label material for the primary label 48. A roll of material for the secondary label 50 is also provided, and secured to its corresponding spool 54. The label material is routed through a number of rollers 56 in order to locate the labels in a position that they may be secured to the containers as the containers move upon the conveyor 44. As the containers pass the labeling stations, the labels are applied to pre-designated portions along the heights of the containers, but the placement of the labels around the circumferences of the containers is random. Each of the containers 30 receive one or both of the labels, and then proceed to the next processing station in the manufacturing process. As can be appreciated by a review of the FIG. 3, because the containers have circular cross sections, there are no constraining geometrical features on the surfaces of the container and therefore, the labels are randomly located on the exterior circumferences of the container bodies. More specifically, the labels are simply applied to the portion of the container bodies that happen to be facing the label applying stations as the containers move on the conveyor.

FIG. 3 may also represent a printing, engraving, embossing, etching, or some other indicia applying machine in which the symbols are placed randomly across the circumference of the containers. For example, instead of the use of labels, one or more printing stations may be disposed along the machine in which printing is applied to the container. Since there is no particular orientation of the container that is acquired in order to conduct the printing, the printing will occur in a truly random manner across the circumference of the container.

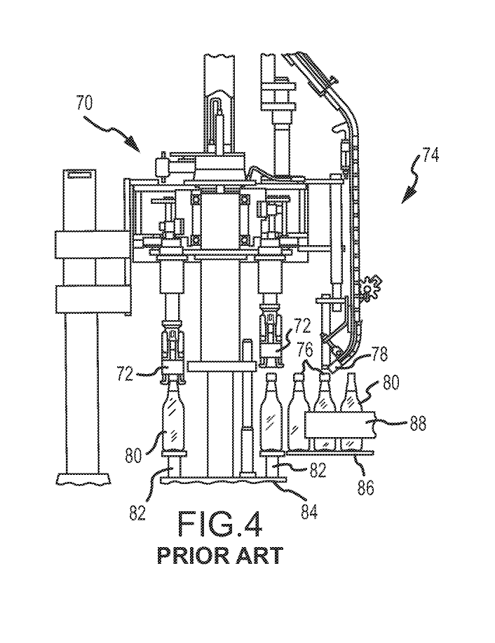

Referring to FIG. 4, yet another example prior art machine is illustrated, namely, a machine that applies caps or crowns to a container. As shown, the machine 70 may include a plurality of chucks 72 that are used to crimp crowns or screw caps over the mouths of the containers 80. The machine is further illustrated as including a cap/crown feeder 74 with a dispensing chute 78 that releases the caps/crowns 76 sequentially, one over each container 80 as the containers move on a conveyor 86 under the feeder 74. One or more guiderails 88 may be provided to maintain the containers 80 in an upright stabilized position. The containers 80 are then sequentially transported by carousel 84 to pedestals 82. The pedestals are each vertically aligned with a corresponding chuck 72. The chucks 72 crimp the crowns over the mouths of the containers, or if caps are used, the chucks 72 thread the caps over the containers 80. Once the caps/crowns 76 are attached, the containers are discharged to a next manufacturing processing station (not shown). As can be appreciated by the FIG. 4, there is no particular or pre-designated circumferential orientation of the containers 80 when receiving the caps 76. Therefore, the circumferential orientation of the caps/crowns as compared to the mouths of the containers is a random event.

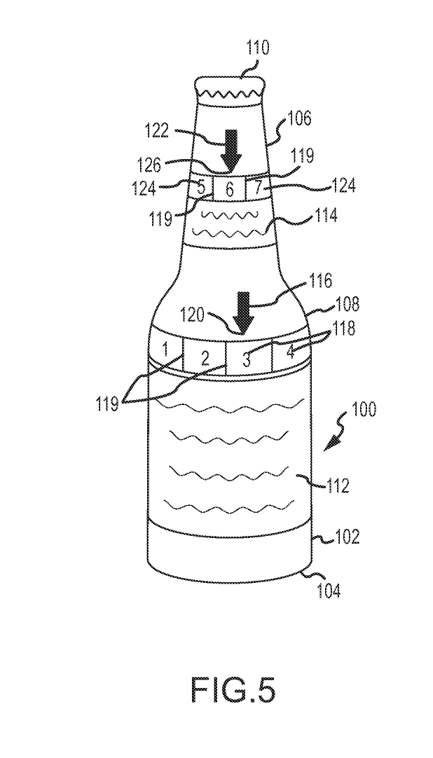

Referring to FIG. 5, a first embodiment of the invention is illustrated in the form of a container 100 that incorporates the randomly generated identifier. In FIG. 5, the container can be in the form of a plastic or glass bottle. Accordingly, the container 100 includes a base 104, a substantially cylindrical shaped body 102, a neck 106, and a transition area or shoulder 108 located between the neck 106 and the body 102. A cap or crown 110 covers the open mouth of the container. One or more labels may be applied to the container 100. FIG. 5 illustrates both a main label 112 and a neck label 114. The main and neck labels may also include portions thereof with symbols 118 and 124, respectively. The symbols 118 and 124 may be letters, numbers, images of objects, designs, or combinations thereof that are spaced from one another around a portion of the circumference of each of the containers. The circumferential positions of the symbols are random since the label when applied is located randomly around some portion of the circumference of the container. In the example of FIG. 5, the symbols are shown as numbers. Although the symbols 118 and 124 are illustrated as being part of the respective main and neck labels, the symbols 118 and 124 could be placed on the container 100 in different ways, to include by etching on the container surface, printing, embossing, or other methods of image transfer in which the transfer occurs in a random manner with respect to locating the symbols along the circumference of the container. Additionally, the symbols 118 and 124 are shown as being separated from one another by delineating lines 119. However, depending upon the type of symbols used on a container, the delineating lines may not be necessary to visually separate the symbols from one another.

Markers 116 and 122 are also provided on the container in order to indicate what prize the consumer has won. The markers may be applied by any number of means to include printing, embossing, etching, and the like. In FIG. 5, the markers 116 and 122 are illustrated as arrow shaped elements with arrow tips 120 and 126 which point or direct the consumer to the corresponding symbol 118/124. Thus, in the FIG. 5, the marker 116 points to the number 3, and the number 3 indicates whether the consumer has won a prize. For the second group of symbols 124, the marker 122 is aligned such that the selected or indicated symbol is the number 6; therefore the number 6 indicates what prize, if any, has been won. Although the FIG. 5 utilizes two groups of markers and symbols, it should be understood that only one marker/symbol group is required. The use of a second symbol/marker group could be used to indicate a second prize, or a second level or grade of prize, depending upon a pre-established relationship between the symbols.

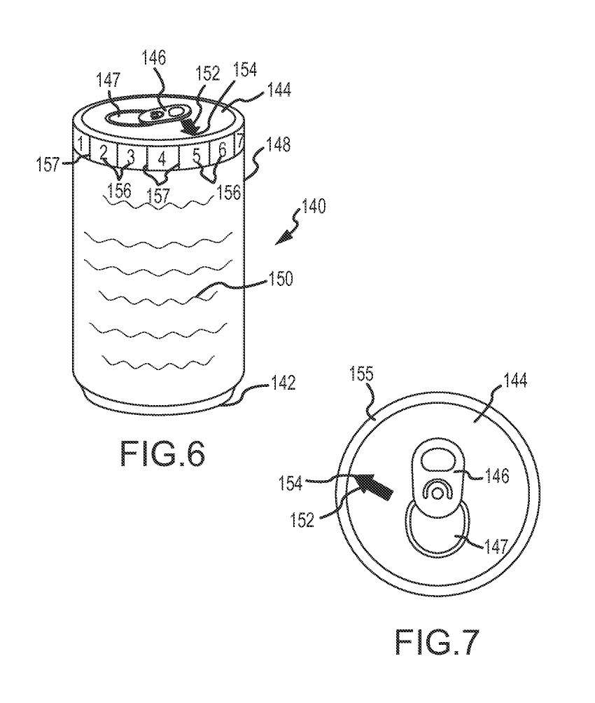

Referring to FIG. 6, yet another embodiment is illustrated with respect to a metallic container 140, such as a traditional aluminum or steel container used to hold a beverage. The container 140 includes standard elements to include a base 142, a body or sidewall 148, a top or end 144, an opening tab 146 and a puncturable panel 147 forming the mouth of the container when punctured. Labeling of the container is typically achieved by printing indicia 150 on the container. Near the top edge of the side wall 148 are positioned a plurality of symbols 156. A marker 152 is disposed on the can end 144, with the tip of the marker 154 indicating alignment with a symbol 156. In example of FIG. 6, the designated symbol is the number 5. As with the embodiment of FIG. 5, the symbols may be combinations of different letters, numbers, etc. The symbols 156 may be applied to the container in the same manner in which the container is labeled, such as by various forms of printing or embossing in which the symbols are applied in a random manner along the circumference of the container. Alternatively, the symbols 156 may be made part of a strip of material that is adhered to the sidewall 148 of the container, the strip of material being applied also in a random manner like a label. Delineating lines 157 are also provided in order to ease the viewable separation between the symbols 156, but these lines 157 may not be necessary depending upon the type of symbol used.

Referring to FIG. 7, it shows that the marker 152 is located near the peripheral edge 155 of the can end so that the consumer may more easily view the relationship between the tip 154 of the marker 152 and the symbols 156.

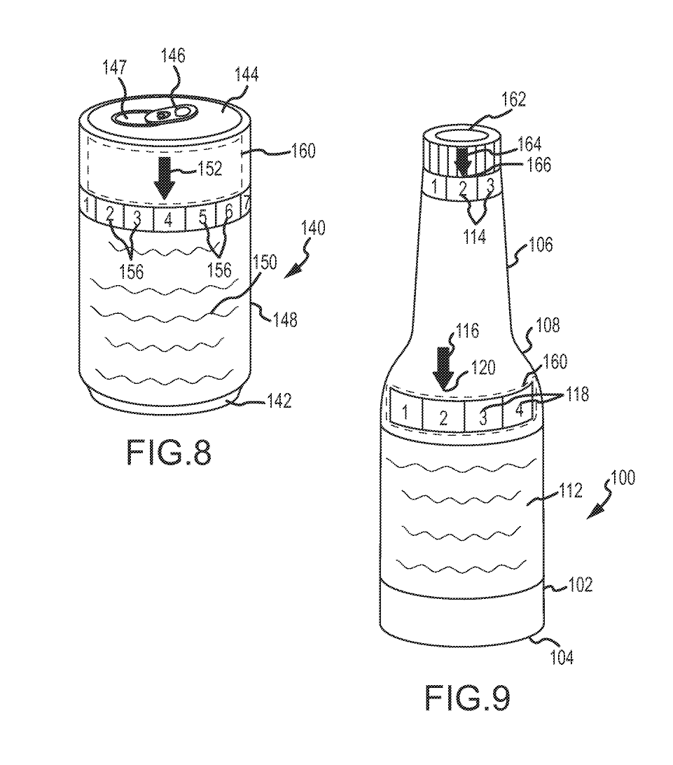

Referring to FIG. 8, yet another embodiment is illustrated with respect to a metallic container 140. In the embodiment of FIG. 8, instead of placing the marker 152 on the can end 144, the marker 152 is placed on the sidewall 148 of the container. Accordingly, the symbols 156 are placed further down on the sidewall enabling the marker 152 to point or indicate the aligned symbol 156.

FIG. 8 also illustrates a disguising label 160 that hides or disguises the particular location of the marker 152. The label 160 is shown in phantom lines. The label 160 can be a removable adhesive label. Prior to purchase, a consumer would not be able to view the particular relationship between the marker 152 and the symbols 156. After purchase, the consumer can peel off the disguising label 160.

Referring to FIG. 9 in yet another embodiment, the primary label 112 and the marker 116 are shown in the same position as shown with respect to the embodiment of FIG. 5. However, the symbols 118 are covered with the disguising label 160 that prevents the consumer from viewing the relationship between the marker 116 and the symbols 118 prior to purchase. Thus, a disguising label can be used to cover the marker(s), the symbol(s), or both. FIG. 9 also illustrates a different configuration with respect to a second marker and symbol combination. As shown, a second marker 164 with indicating tip 166 is applied to the side edge of the cap 162. As set forth above with respect to the explanation of the capping machine in FIG. 4, the random circumferential attachment of a cap or crown to the mouth of the container is a random event that therefore may also be used to establish the random relationship between the position of the marker 164 and the symbols 114.

In accordance with the method of the invention, a marker and at least one symbol are randomly located and then applied to the circumference of a container. The marker is positioned vertically so that the marker indicates alignment with a symbol, and the symbol determining whether the consumer has won a prize. The particular circumferential location or position of the marker and the symbols are random and any prize won is therefore by random chance.

As can be seen from the description of the preferred embodiments, container processing/assembling equipment provides random positions for the markers and symbols along the circumferences of the containers. Therefore, truly random chances or opportunities are provided to the consumer for winning a prize. This approach to creating a marketing tool in conjunction with sale of a beverage can enhance the overall commercial viability of the product, particularly for those consumers who enjoy the opportunity to win a prize with purchase of the product.

Although the foregoing invention has been described with respect to various preferred embodiments, it should be understood that the invention may be modified in its form commensurate with the scope of the claims appended hereto.

What is claimed is:

1. A container including a randomly generated identifier comprising:
a container;
at least one symbol placed on the container;
a marker placed on the container adjacent the symbol to indicate alignment between the marker and symbol;
at least one of the marker or symbol is circumferentially randomly located on the container; and
the at least one symbol represents a potential prize based upon pre-established criteria in which a pre-selected symbol is a prize winner if the marker aligns with the pre selected symbol.

2. The container, as claimed in claim 1, wherein:
the plurality of symbols extends substantially horizontally around a sidewall of the container.

3. The container, as claimed in claim 1, wherein:
said marker or symbol is incorporated on a label of the container, said label being circumferentially randomly located on the container.

4. The container, as claimed in claim 1, wherein:
the container is a bottle.

5. The container, as claimed claim 1, wherein:
the container is a can.

6. The container, as claimed in claim 1, wherein:
said marker is in the shape of a pointing element.

7. The container, as claimed in claim 3, wherein:
the label is secured to a body sidewall of the container.

8. The container, as claimed in claim 3, wherein:
said label is secured to a neck sidewall of the container.

9. The container, as claimed in claim 1, wherein:
the marker is disguised by a removable label.

10. The container, as claimed in claim 1, wherein:
the marker is disguised by a removable overcoat material.

11. The container, as claimed in claim 1, wherein the marker and the at least one symbol are applied to the container by at least one of printing, engraving, embossing, etching, or the marker and the at least one symbol are incorporated on a label applied to the container.

12. A method of generating a random identifier incorporated on a container, said method comprising:
providing a container;
locating at least one symbol on the container;
locating a marker on the container and positioned adjacent the symbol to indicate alignment between the marker and the symbol;
the marker or symbol being randomly circumferentially located on the container; and
wherein the at least one symbol represents a potential prize based upon pre-established criteria in which a pre-selected symbol is a prize winner if the marker aligns with the pre-selected symbol.

13. A method, as claimed in claim 12 wherein:
said plurality of symbols extends substantially horizontally around a portion of a circumference of the container.

14. A method, as claimed in claim 12, wherein:
said marker or symbol is incorporated on a label of the container, said label being circumferentially randomly located on the container.

15. A method, as claimed in claim 12, further including:
securing the label to a body sidewall of the container.

16. A method, as claimed in claim 12, further including:
applying said label to a neck sidewall of the container.

17. A method, as claimed in claim 12, wherein:
at least one of said symbol or said marker is disguised thereby preventing a consumer viewing an orientation between the marker and at least one symbol and therefore preventing the consumer from knowing whether the prize has been won until the marker or symbol is not disguised.

18. A method, as claimed in claim 12, wherein:
the marker is disguised by a removable label.

19. A method, as claimed in claim 12, wherein:
the marker is disguised by a removable overcoat material.

20. A method, as claimed in claim 12, wherein the marker and the at least one symbol are applied to the container by at least one of printing, engraving, embossing, etching, or the marker and the at least one symbol are incorporated on a label applied to the container.

21. A method of providing a prize offering including use of a random identifier incorporated on a container, said method comprising:
providing a container;
locating at least one symbol on the container;
locating a marker on the container and positioned adjacent the symbol to indicate alignment between the marker and the symbol;
the marker or symbol being randomly circumferentially located on the container; and
wherein the at least one symbol represents a potential prize based upon pre-established criteria in which a pre-selected symbol is a prize winner if the marker aligns with the pre-selected symbol.
